(19) United States
(12) Patent Application Publication
(10) Pub. No.: US 2019/0340653 A1
(43) Pub. Date: Nov. 7, 2019

(54) Method and System for Personalization of Advertisement Content

(71) Applicant: Capital One Services, LLC, McLean, VA (US)

(72) Inventors: Parvesh Kumar, Plano, TX (US); Raman Bajaj, Frisco, TX (US); Arjun Dugal, Dallas, TX (US); Sanjiv Yajnik, McLean, VA (US); David Kang, Plano, TX (US); Terry Ni, Plano, TX (US); Janardhan Prabhakara, Allen, TX (US); Praveen Tandra, Allen, TX (US); Maitreya Kundurthy, Richardson, TX (US); Connor Foley, Frisco, TX (US)

(73) Assignee: Capital One Services, LLC, McLean, VA (US)

(21) Appl. No.: 15/969,277

(22) Filed: May 2, 2018

(51) Int. Cl. G06Q 30/02; H04L 29/08; H04L 29/06

(52) U.S. Cl. CPC G06Q 30/0269; H04L 63/102; H04L 67/146; G06Q 30/0275

(57) ABSTRACT

Embodiments disclosed herein generally relate to a system and method for personalization of advertisement content. A computing system receives an HTTP request to access a webpage. The HTTP request includes a visitor identifier. The computing system parses the HTTP request to identify the visitor identifier contained therein. The computing system transfers the visitor identifier to a remote advertisement server. The computing system receives an advertisement call from a web browser executing on the remote computing system. The advertisement call includes the visitor identifier. The computing system generates a customized advertisement based at least on content accessed by the remote computing system on the webpage. The computing system transmits the customized advertisement to the web browser for display with the website on the remote computing system. The website is hosted by the third-party web server.

### FIELD OF THE DISCLOSURE

The present disclosure generally relates to a method and a system for personalization of advertisement content.

### BACKGROUND

As Internet accessibility has increased, consumers have become increasingly more subjected to advertising messages on virtually every available communication medium. Consumers are constantly exposed to “pop-ups” and “banner ads” when viewing websites or electronic documents. Despite the prevalence of advertisements today, the effectiveness of these advertisements remains elusive due to difficulty in attributing a consumer's purchase with any particular advertisement, advertising campaign, or means of presenting advertisements. Thus, entities wishing to advertise are left with uncertainty regarding the most effective means of reaching their target audience, and the most effective message to display to their target audience.

### SUMMARY

Embodiments disclosed herein generally relate to a system and method for personalization of advertisement content. A computing system receives, from a remote computing system, a hypertext transfer protocol (HTTP) request to access a webpage. The HTTP request includes a visitor identifier. The computing system parses the HTTP request to identify the visitor identifier contained therein. The computing system transfers the visitor identifier to a remote advertisement server. The remote advertisement server is configured to generate advertisements for a plurality of additional webpages. The computing system receives an advertisement call from a web browser executing on the remote computing system. The advertisement call is for an advertisement space on a website hosted by a third-party web server. The advertisement call includes the visitor identifier. The computing system parses the advertisement call to identify the visitor identifier container therein. The computing system generates a customized advertisement based at least on content accessed by the remote computing system on the webpage. The computing system transmits the customized advertisement to the web browser for display with the website on the remote computing system. The website is hosted by the third-party web server.

In some embodiments, the visitor identifier in the HTTP request includes receiving a visitor cookie included in the HTTP request. The visitor cookie corresponds to the visitor identifier.

In some embodiments, receiving the advertisement call from the web browser is indicative of the computing system winning a bid for the advertisement.

In some embodiments, receiving the HTTP request to access the webpage includes receiving log-in information associated with an account. The log-in information is associated with a log-in identifier.

In some embodiments, the computing system associates the log-in identifier with the visitor identifier. The computing system further stores the association in a database.

In some embodiments, generating the customized advertisement based at least on content accessed by the remote computing system on the webpage includes the computing system identifying whether the visitor identifier is associated with a log-in identifier. The computing system determines that the visitor identifier is associated with the log-in identifier. The computing system generates the customized advertisement based on content accessed by the remote server and content particular to the account logged into.

In some embodiments, receiving the advertisement call from the web browser executing on the remote computing system is responsive to the remote computing system visiting both the web page and an additional web page loaded on the web browser.

In another embodiment, a system is disclosed herein. The system includes a processor and a memory. The memory has programming instructions stored thereon, which, when executed by the processor, performs an operation. The operation includes receiving, by a computing system, an advertisement call from a web browser executing on a remote computing system. The advertisement call includes identification information. The operation further includes identifying that the received identification information includes a visitor identifier. The visitor identifier is indicative of the remote computing system accessing content managed by the computing system. The operation further includes generating a customized advertisement based at least on content accessed by remote computing system on a webpage managed by the computing system. The operation further includes transmitting the customized advertisement to the web browser for display on the remote computing system.

In some embodiments, the received identification information is a visitor cookie.

In some embodiments, receiving the advertisement call from the web browser executing on the remote computing device is indicative of winning a bid for the advertisement.

In some embodiments, the operation further includes identifying that the visitor identifier is associated with a log-in identifier corresponding to a user account.

In some embodiments, the log-in identifier is received by the processor when the remote computing system attempt to log into the user account.

In some embodiments, the operation of generating the customized advertisement based at least on content accessed by the remote computing system on the webpage includes identifying whether the visitor identifier is associated with a log-in identifier, determining that the log-in is associated with the log-in identifier, and generating the customized advertisement based on content accessed by the remote server and content particular to the account logged into.

In some embodiments, the operation of receiving the advertisement call from the web browser executing on the remote computing system is responsive to the remote computing system visiting both the web page and an additional web page loaded on the web browser.

In some embodiments, the operation of identifying that the received identification information includes the visitor identifier includes identifying whether the identification information includes information stored in a database as a result of remote computing system visiting a webpage managed by the computing system.

In another embodiment, a method is disclosed herein. A computing system receiving a first set of identification information comprising a visitor identifier from a remote computing system. The identification information corresponds to an identification of a client device that has accessed a webpage hosted by the remote computing system. The computing system receives, from a web browser executing on the client device, an advertisement request. The advertisement request includes a second set of identification information. The computing system parses the second set of identification information to identify whether the second set of identification information comprises the visitor identifier. The computing system determines that the second set of identification information comprises the visitor identifier. The computing system initiates a real-time bidding process among a plurality of advertising entities that includes the remote computing system to determine an entity to fulfill the advertisement request. The computing system routes the advertisement request to the entity that won the real-time bidding event.

In some embodiments, routing the advertisement request to the entity that won the real-time bidding process includes the computing system routing the advertisement request to the remote computing system, upon identifying that that remote computing system won the real-time bidding process.

In some embodiments, routing the advertisement request to the remote computing system includes transmitting the identified visitor identifier to the remote computing system.

In some embodiments, the computing system assigns a unique identifier to the web browser.

In some embodiments, the computing system associates the unique identifier with the visitor identifier.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one embodiment.

FIG. 2 is a flow diagram illustrating a method of generating a database of visitor identifiers, according to one embodiment.

FIG. 3 is a flow diagram illustrating a method of managing an advertisement request, according to one embodiment.

FIG. 4 is a flow diagram illustrating a method of generating a personalized advertisement, according to one embodiment.

FIG. 5 is a block diagram illustrating communications among components of a computing environment, according to one embodiment.

FIG. 6 is a block diagram illustrating a computing environment, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure generally relates to a method and system for delivering customized advertisements to visitors of a website. One or more techniques disclosed herein relates to leveraging identifying information in hypertext transfer protocol (HTTP) requests to deliver customized advertisements to visitors (or customers) of a business (e.g., a financial institution). For example, a web server of a financial institution may store visitor identifiers of visitors to one or more webpages, and associate that information with log-in identifiers to those visitors that also have an account with the business.

In some embodiments, an advertisement server may receive an advertisement request from a web browser, responsive to web browser determining that a requested web page includes an advertisement space included therein. In conventional systems, an advertisement server may initiate a bidding process among various advertisers for the advertisement space on the web page. Following the bidding process, the advertisement server may provide a generic advertisement to the web browser for the application. Such process stands in contrast to the techniques disclosed herein.

In some embodiments, the disclosed web server may transmit to the advertisement agent a set of visitor identifiers. A visitor identifier is a unique identifier (e.g., cookie, computer footprint, etc.) generated by the web server that is passed to the web browser of client device such that the web browser (or user accessing web browser) may be uniquely identified on subsequent visits. The disclosed web server may instruct the advertisement server that the disclosed web server may desire to participate in those bidding processes that include web browsers having a visitor identifier generated by the web server. Accordingly, the disclosed web server may transmit the generated set of visitor identifiers to the advertisement agent, such that the advertisement agent may parse through one or more identifiers included in the advertisement request (i.e., cookie information from a variety of third party web sites) and identify the visitor identifier. Subsequently, if the business wins the bidding process, the advertisement agent may route the advertisement request to the disclosed web server, such that the disclosed web server can generate a customized advertisement based on the visitor identifier.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

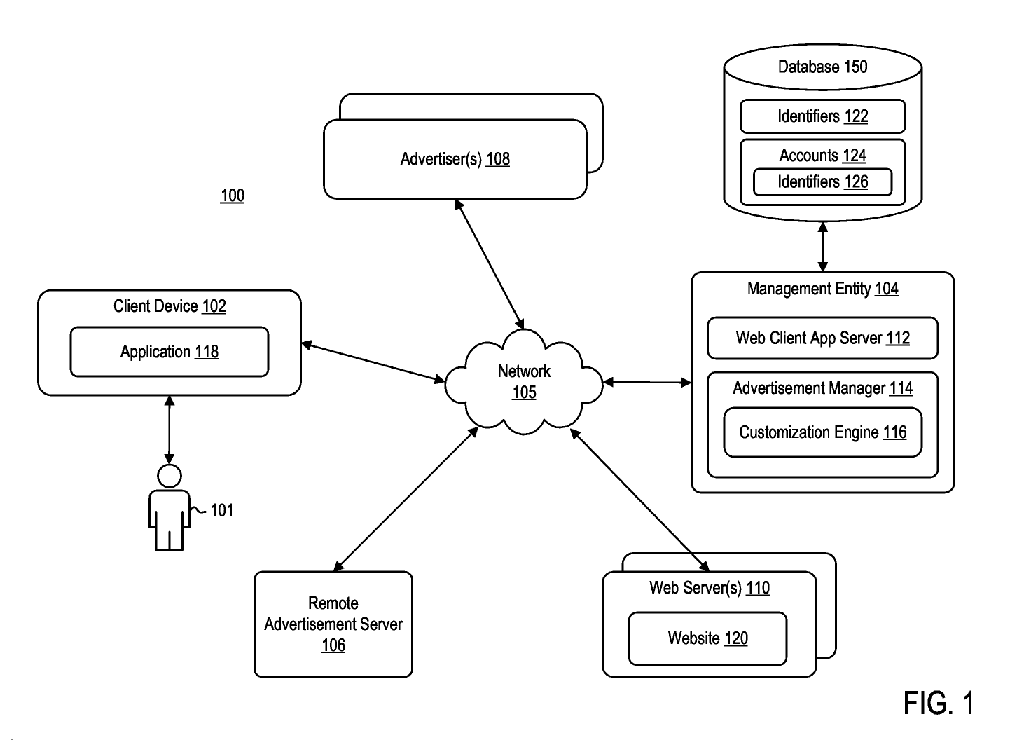

FIG. 1 is a block diagram illustrating a computing environment 100, according to one embodiment. Computing environment 100 may include a client device 102, a management entity 104, a remote advertisement server 106, one or more advertisers 108, and one or more web servers 110. Client device 102, management entity 104, remote advertisement server 106, one or more advertisers 108, and one or more web servers 110 may be in communication via network 105. Client device 102 may be operated by user 101. For example, client device 102 may be a mobile device, a tablet, a desktop computer, or any computing system having the capabilities described herein.

Client device 102 may include at least an application 108. Application 108 may be representative of a web browser that allows access to a website or a stand-alone application. User 101 may access application 108 to access functionality of management entity 104. User 101 operating client device 102 may communicate over network 105 to request a webpage, for example, from web client application server. For example, client device 102 may be configured to execute application 118 to access content managed by web client application server 112. The content that is displayed to user 101 may be transmitted from web client application server 112 to client device 102, and subsequently processed by application 108 for display through a graphical user interface (GUI) of client device 102.

User 101 may further access application 108 to access functionality of one or more web servers 110. User 101 operating client device 102 may communicate over network 105 to request a webpage (e.g., from website 120) from web server 110. For example, client device 102 may be configured to execute application 118 to access content managed by each web server 110. The content that is displayed to user 101 may be transmitted from web server 120 to client device 102, and subsequently processed by application 118 for display through a GUI of client device 102.

To access functionality of either web client application server 112 or web server 110, application 118 may submit a hypertext transfer protocol (HTTP) request to web client application server 112 or web server 110. With respect to web client application server 112, when web client application server 212 receives the HTTP request from application 118, web application server 212 may identify whether an identifier (or “cookie”) is included in the HTTP request. The identifier indicates to web client application server 112 that user 101 has previously visited a web page of the website hosted by web client application server 112. In examples in which user 101 has not visited a webpage of the website hosted by web client application server 112, web client application server 112 would identify that HTTP request does not contain an identifier, and generate a unique identifier for transmission back to application 118. Identifier may uniquely identify application 118 among all the web browsers/applications accessing content hosted by web client application server 112. A similar process is performed by web server 110 when user 101 attempts to access content hosted by one of the web servers 110. In subsequent HTTP requests from application 118 to web client application server 112, the HTTP requests include the unique identifier generated by web client application server 112 and transmitted to application 118.

Management entity 104 may be representative of a computing platform of a business entity. For example, management entity 104 may be representative of a financial institution computing platform (e.g., bank, lender, credit card company, etc.), that allows users to transact, view account information, transfer currency, and the like. Management entity 104 may be in communication with database 150. Database 150 may include visitor identifiers 122 and accounts 124. In some embodiments, visitor identifiers 122 are cookies which are generated by web client application server 112 when web browsers/applications send initial HTTP requests to web client application server 112. In some embodiments, visitor identifiers 122 may be a computer footprint or browser fingerprint, which allows application 118 to be identifiable over the Internet. For example, a computer footprint or browser fingerprint may include a hashed version of one or more of a browser version, language, country, device type, and the like. Accounts 124 may correspond to user accounts of one or more users associated with management entity 104. In some embodiments, management entity 104 may be a financial institution. For example, user 101 may have an account 124 with management entity 104. Accordingly, user 101 may access account 124 that is managed by web client application server 112. Each account 124 may include log-in identifiers 126. Each log-in identifier 126 may be a cookie that is generated upon a user logging into his or her account via application 118. Web client application server 112 may associate, for example, user's 101 log-in identifier 126 with user's 101 visitor identifier 122. Such association may be noted in database 150. Accordingly, web client application server 112 may identify whether a user accessing a webpage has an account with management entity 104 without user authentication (i.e., logging into his/her account).

Generally, webpages of websites 120 may include one or more pre-defined spaces for advertisements to be displayed therein. When user 101 requests a webpage of website 120 hosted by web server 110 via HTTP request, web server 110 may return content which is composed of a hypertext markup language (HTML) document. Included in the HTML document may be an address of a remote advertisement server 106. Application 118 may, in turn, communicate with remote advertisement server 106 for retrieval of an advertisement to display in advertisement space on webpage of website 120 hosted by web server 110.

Advertisement server 106 may be configured to manage advertisement content across a plurality of websites 120. Advertisement server 106 may store one or more advertisements 130 corresponding to one or more advertisers 108. After web browser 118 receives the HTML document from web server 110 or web client application server 112 with the address of advertisement server 106, web browser 118 may submit an advertisement request to advertisement server 106. Advertisement server 106 may transmit an advertisement to application 118 for display in a webpage, upon selecting an advertisement among the one or more advertisements 130.

Management entity 104 may further include advertisement manager 114. In some embodiments, advertisement manager 114 may be a server, including one or more computing systems. In some embodiments, advertisement manager 114 may be comprised of one or more software modules. The one or more software modules are collections of code or instructions stored on a media (e.g., memory of management entity 104) that represent a series of machine instructions (e.g., program code) that implements one or more algorithmic steps. Such machine instructions may be the actual computer code the processor of management entity 104 interprets to implement the instructions, or, alternatively, may be a higher level coding of the instructions that is interpreted to obtain the actual computer code. The one or more software modules may also include one or more hardware components. One or more aspects of an example algorithm may be performed by the hardware components (e.g., circuitry) itself, rather as a result of an instruction.

Rather than storing advertisements with advertisement server 106, management entity 104 may store one or more advertisements (e.g., one or more advertisement templates) in advertisement manager 114. Accordingly, if advertisement server 106 determines that advertisement manager 114 won the bidding process, advertisement server 106 may route the advertisement request to advertisement manager 114. Advertisement manager 114 may include a customization engine 116. Customization agent 116 may include one or more software modules. The one or more software modules are collections of code or instructions stored on a media (e.g., memory) that represent a series of machine instructions (e.g., program code) that implements one or more algorithmic steps. Such machine instructions may be the actual computer code the processor interprets to implement the instructions, or, alternatively, may be a higher level coding of the instructions that is interpreted to obtain the actual computer code. The one or more software modules may also include one or more hardware components. One or more aspects of an example algorithm may be performed by the hardware components (e.g., circuitry) itself, rather as a result of an instruction.

Customization engine 116 may be configured to generate a customized advertisement for display with webpage. For example, when advertisement server 106 routes the advertisement request to web client application server 112, the advertisement request may include all cookies (i.e., identifiers) associated with application 118. Accordingly, customization engine 116 may parse the advertisement request to determine whether a visitor identifier 122 exists. If visitor identifier 122 does not exist, customization engine 116 may send a non-customized advertisement to application 118.

If visitor identifier 1122 does exist, customization engine 116 may determine whether there is a log-in identifier 126 associated with visitor identifier 122. Accordingly, customization engine 116 may query database 150 to determine if a log-in identifier 126 is associated with visitor identifier 122. If customization engine 116 determines that a log-in identifier 126 associated with visitor identifier 122 does not exist, customization engine 116 may generate a customized advertisement based on webpages associated with visitor identifier 122. For example, if user 101 visited a webpage corresponding to a type of credit card, customization engine 116 may generate an advertisement with a customized offer to user 101 for the credit card.

If, however, customization engine 116 determines that a log-in identifier 126 is associated with visitor identifier 122, customization engine 116 may generate a highly customized advertisement. A highly customized advertisement may be based on, not only webpages associated with visitor identifier 122, but activity associated with account 124. Accordingly, customized engine 116 may tailor the customized advertisement more closely to user 101. For example, a highly customized advertisement may include a more tailored credit card offer, in which the offered credit line is based upon user's checking account, credit score, savings account, and the like. In another example, a highly customized advertisement may include an offer for user 101 to come into his/her local financial institution branch to discuss an offer in more detail, based off of address information in user account 124. In another example, a highly customized advertisement may recite, “Hello Jim, as a loyal customer with a credit card account, your new auto loan rate is 5%. Click for details.”

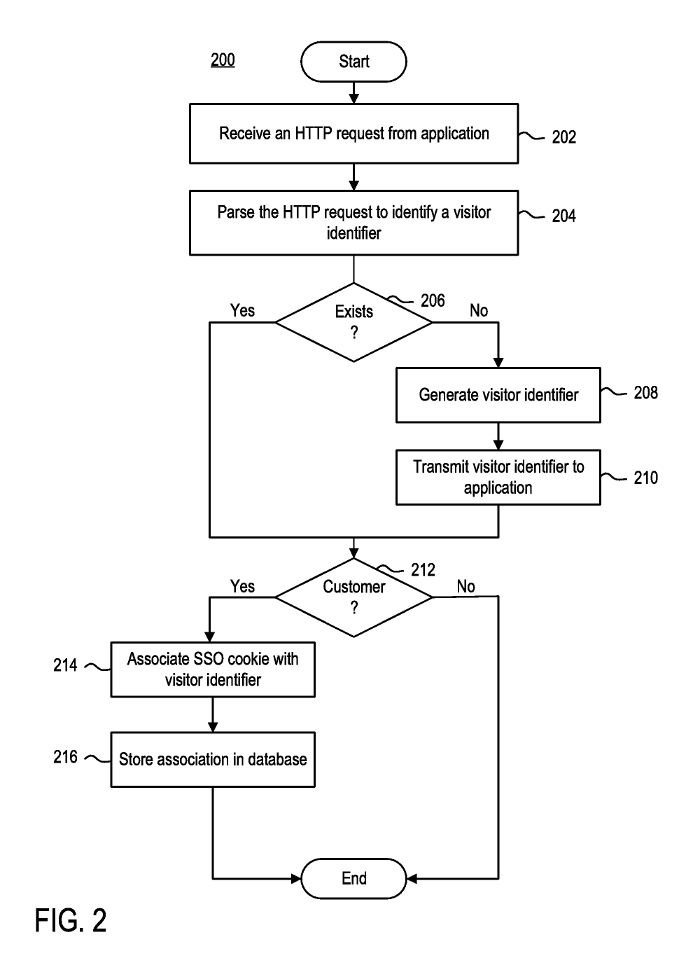

FIG. 2 is a flow diagram illustrating a method 200 of generating a database of visitor identifiers, according to one embodiment. Although method 200 is discussed in conjunction with one or more components of FIG. 1, those skilled in the art would readily understand that method 200 may be carried out by any suitable computing system.

Method 200 begins at step 202. At step 202, web client application server 112 may receive an HTTP request from application 118. For example, application 118 may transmit an HTTP request to web client application server 202 to access a webpage of a website hosted by web client application server 202. HTTP request may include one or more website specific identifiers (i.e., cookies) associated with application 118. Each website specific identifier may indicate to a web server whether user 101 has previously visited a webpage of a website hosted by that web server. For example, HTTP request may include a website specific identifier (e.g., a visitor identifier 122) that notifies web client application server 104 that user 101 has previously visited a webpage of a website hosted by web client application server 112.

At step 204, web client application server 112 may parse the HTTP request to determine whether HTTP request includes a visitor identifier. For example, web client application server 112 may parse through one or more website specific identifiers to determine whether the one or more website specific identifiers includes an identifier specific to a webpage of a website hosted by web client application server 104.

If at step 206, web client application server 112 determines that the HTTP requests includes a visitor identifier, then method 200 proceeds to step 212.

If, however, at step 206, web client application server 112 determines that the HTTP request does not include a visitor identifier 122, then at step 208, web client application server 112 generates a visitor identifier 122 for application 118. For example, web client application server 112 may generate a unique visitor identifier 122 for application 118. Visitor identifier 122 may uniquely identify application 118 among all the web browsers/applications accessing content hosted by web client application server 112. Web client application server 112 may store visitor identifier 122 in database 150, such that application 118 may be identified in subsequent HTTP requests. At step 210, web client application server 112 may transmit visitor identifier 122 to application 118, such that application 118 may include visitor identifier 122 in subsequent HTTP requests to web client application server 112.

At step 212, web client application server 112 may determine whether visitor identifier 122 is associated with a customer account 124. For example, web client application server 112 may query database 150 with visitor identifier 122 to determine whether visitor identifier 122 is associated with a customer account 124.

If at step 212, web client application server 112 determines that visitor identifier 122 is not associated with a customer account 124, then method 300 ends. If, however, web client application server 112 determines that visitor identifier 122 is associated with a customer account 124, then at step 216, web client application server 112 associated a log-in identifier 126 associated with customer account 124 with visitor identifier 122. For example, when a user 101 logs into his or her customer account 124, web client application server 112 may “drop a cookie” associated with the log-in (i.e., web client application server 112 may generate a log-in identifier 126 that uniquely identifies application 118). In other words, when a user 101 logs into his or her customer account 124, web client application server 112 may generate a string of information that uniquely identifiers application 118 accessing his/her account 124. Log-in identifier 126 may be of a different format than visitor identifier 122, such that web client application server 112 may decipher the two. In some embodiments, log-in identifier 126 may be erased responsive to user 101 logging out of his/her user account 124. By associating visitor identifier 122 with log-in identifier 126, web client application server 112 may identify that application 118 is associated with a user 101 having a user account 124, even in situations where user 101 is not logged in. At step 218, web client application server 112 may store the association in database 150.

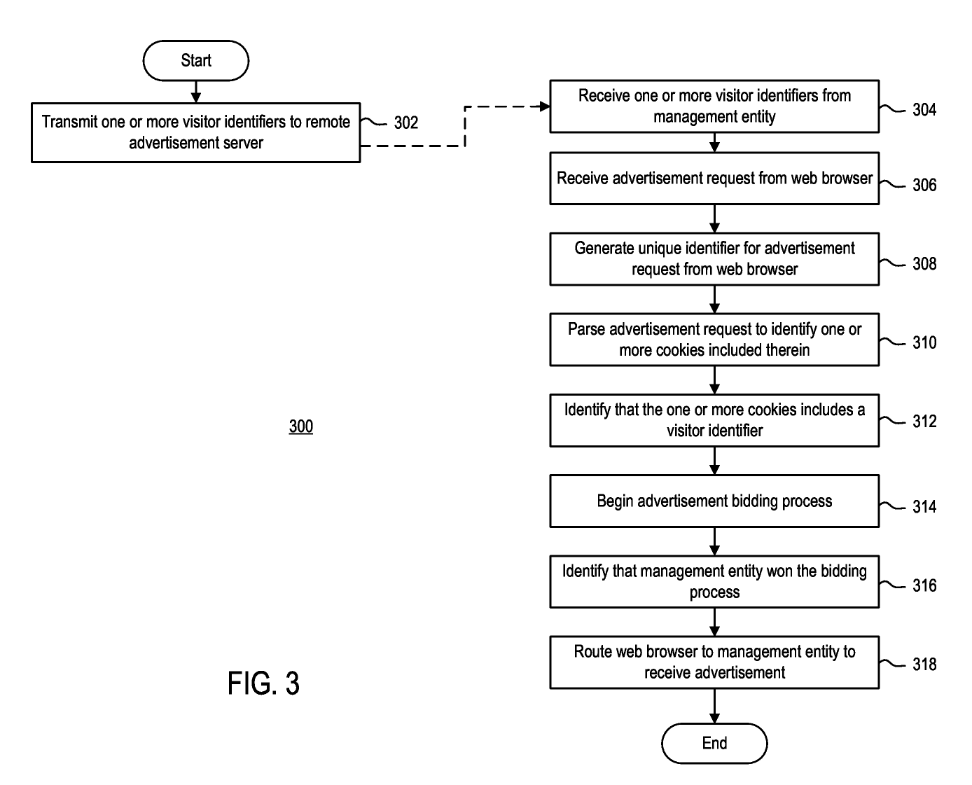

FIG. 3 is a flow diagram illustrating a method 300 of managing an advertisement request, according to one embodiment. Method 300 begins at step 302. At step 302, management entity 104 may transmit one or more visitor identifiers 122 to remote advertisement server 106. For example, web client application server 112 may retrieve one or more visitor identifiers 122 from database 150 and transmit the one or more visitor identifiers 122 to advertisement server 106. Each visitor identifier 122 corresponds to a web browser/application that has accessed a webpage of a website hosted by web client application server 112.

At step 304, advertisement server 106 receives one or more visitor identifiers 122 from management entity 104. At step 306, advertisement server 106 may receive an advertisement request from a web server 120. For example, application 118 may receive an HTML document from web client application server 130, responsive to transmitting an HTTP request to web server 120. HTML document may include an address of advertisement server 106. Application 118 may, in turn, communicate with advertisement server 106 for retrieval of an advertisement to display in advertisement space on webpage of website hosted by web server 110.

At step 306, advertisement server 106 receives an advertisement request from application 118. For example, following an HTTP request, application 118 receives the HTML document from web client application server 130. In the HTML document is an address of the advertisement server 106. The address of advertisement server in HTML document is indicative of the requested webpage having an advertisement space included therein. To receive the advertisement for the requested webpage, application 118 may transmit an advertisement request to advertisement server 106.

At step 308, advertisement server 106 may generate a unique identifier for the advertisement request from application 118. For example, advertisement server 106 may generate a server identifier that uniquely identifies application 118 for subsequent advertisement requests. By generating a server identifier for the advertisement request from application 118, advertisement server 106 may be able to keep track of the advertisement requests from receipt to the bidding process to the routing of the offer following the bidding process.

At step 310, advertisement server 106 may parse advertisement request to identify one or more identifiers included therein. For example, when application 118 transmits an advertisement request from advertisement server 106, application 118 may include therewith the one or more identifiers included in the HTTP request. In some embodiments, the advertisement request to advertisement server 106 is an HTTP request substantially similar to the HTTP request to web server 110.

At step 312, advertisement server 106 may identify that the one or more identifiers in the advertisement request includes a visitor identifier 122 of the one or more visitor identifiers 122 transferred from management entity 104. For example, advertisement server 106 may parse one or more identifiers in the HTTP request to identify a visitor identifier 122 among the one or more identifiers included in the HTTP request. Determining that a visitor identifier 122 is included in the advertisement requests notifies advertisement server 106 that management entity 104 would like to participate in a bidding process.

At step 314, advertisement server 106 may begin a real-time bidding process for the advertisement space in the webpage to be provided to application 118. In some embodiments, responsive to identifying that the advertisement request includes a visitor identifier 122, advertisement server 106 may notify management entity 104. Receiving a bidding process notification from advertisement server 106 may signal to management entity 104 that management entity 104 is bidding for advertisement space for a user (e.g., user 101) that has previously visited a webpage hosted by web client application server 112.

At step 316, advertisement server 106 may identify that management entity 104 won the bidding process. For example, management entity 104 may have entered the highest bid for advertisement space. In another example, management entity 104 may have won the bidding process based off criteria, such as security practices, business relationships, overall monetary contribution, type of business associated with management entity 104, content of the information to be displayed, or any other factor which may determine the desirability of a providing an advertisement.

At step 318, advertisement server 106 may route application 118 to management entity 104. For example, rather than advertisement server 106 handling the placement of advertisements or forwarding the information to a centralized server, advertisement server 106 may route application 118 to management entity 104. Such direct routing between application 118 and management entity 104 allows management entity 104 to serve an advertisement to application 118 in real-time (or near real-time).

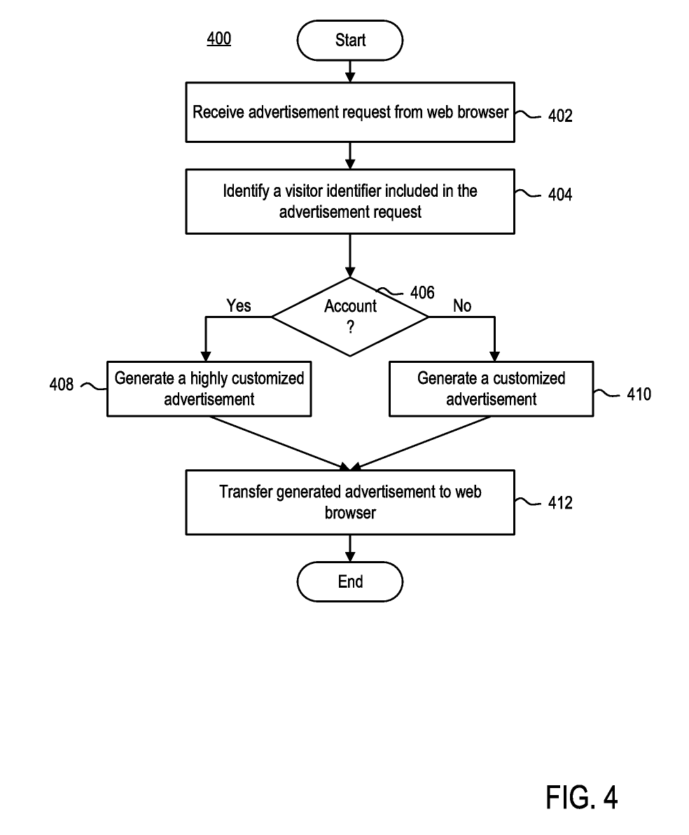

FIG. 4 is a flow diagram illustrating a method 400 of generating a personalized advertisement, according to one embodiment. Method 400 may begin at step 402. At step 402, management entity 104 may receive an advertisement request from application 118. For example, upon winning the bidding process, web client application server 112 may receive an advertisement request that includes the visitor identifier from application 118.

At step 404, management entity 404 may identify the visitor identifier included in the advertisement request. For example, web client application server 112 may parse the received request to extract the visitor identifier from the advertisement request.

At step 406, management entity 404 may determine whether the visitor identifier is associated with a user account 124. For example, customization engine 116 may query database 150 to determine if there is a log-in identifier 126 associated with visitor identifier 122.

If at step 406, management entity 104 determines that there is a log-in identifier 126 associated with visitor identifier 122 (i.e., there is a user account 124 associated with visitor identifier 112), then at step 408, management entity 104 may generate a highly customized advertisement for user 101. For example, customization agent 116 may identify a user account 124 associated with log-in identifier 126. Based off of user account 124 and content viewed by user 101 while browsing one or more webpages of websites hosted by web client application server 112, customization agent 116 may generate a highly customized advertisement. In some embodiments, the highly customized advertisement may include an offer unique to user 101.

If, however, at step 406, management entity 104 determines that there is not a log-in identifier 126 associated with visitor identifier 122 (i.e., there is a not a user account 124 associated with visitor identifier 112), then at step 410, management entity 104 may generate a customized advertisement for user 101. For example, customization agent 116 may identify content viewed by user 101 while browsing one or more webpages of websites hosted by web client application server 112. Customization agent 116 may generate the customized advertisement based on the content viewed by user 101. In some embodiments, the customized advertisement may include an offer unique to user 101.

At step 412, management entity 104 transfers the generated advertisement to application 118. For example, web client application server 112 may generate an HTML response to application 118, wherein the HTML response may include information associated with the generated advertisement. Application 118 may process the HTML response and display the webpage, with the generated advertisement, to user 101.

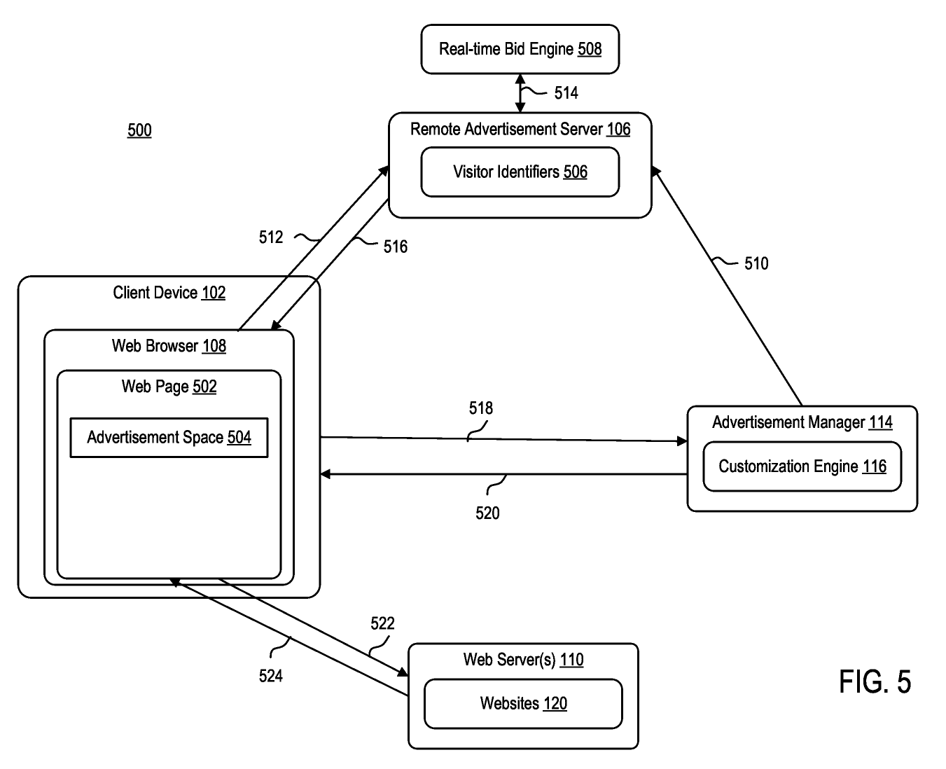

FIG. 5 is a block diagram illustrating communications among components of a computing environment 500, according to one embodiment. As illustrated, computing environment 500 includes client device 102, advertisement manager 114, remote advertisement server 106, and web server 110. As illustrated, client device 102 includes application 118. Application 118 sends (illustrated by arrow 522) an HTTP request 522 to webserver 110 to access a page of website 110. The page of the website 110 includes an advertisement space (illustrated advertisement space 504). In response, webserver 110 generates an HTML document that includes an address of the advertisement server 106. Webserver 110 transmits (illustrated by arrow 524) to application 118.

Application 118 may identify the address of advertisement server 106 in the HTML document. Application 118 may transmit (illustrated by arrow 512) an advertisement request to advertisement server 106. Advertisement request may include one or more identifiers (i.e., cookies) associated with application 118.

Management entity 104 may transmit (illustrated by arrow 510) the one or more visitor identifiers 122 to advertisement server 106. Each visitor identifier 122 corresponds to a user (or more specifically, application 118) that has visited a webpage of a website hosted on web client application server 112. Advertisement server 16 may store visitor identifiers (illustrated visitor identifiers 506).

When advertisement server 106 receives the advertisement request from application 118, advertisement server 106 may parse the advertisement request to identify one or more identifiers associated with application 118. If advertisement server 106 identifies that a visitor identifier 122 is included in the one or more identifiers associated with application 118, advertisement server 106 includes management entity 104 in a bidding process for the advertisement space 504. For example, advertisement server 106 may communicate (illustrated by arrow 514) with a real-time bid engine 508. Bid engine 508 may conduct a bidding process among one or more advertisers and management entity 104.

If advertisement server 106 identifies that management entity 104 has won the bidding process, advertisement server 106 communicates (illustrated by arrow 516) with application 108, such that application 108 is routed to management entity 104 to receive an advertisement. Application 118 requests an advertisement from advertisement manager 114 (illustrated by arrow 518).

Customization engine 116 may generate a customized advertisement for application 118, based, at least, on visitor identifier 122. For example, if customization engine 116 determines that visitor identifier 122 is associated with a log-in identifier 126, customization engine 116 may generate a highly customized advertisement based at least on content viewed by user 101 on webpages hosted by web client application server 112 and information associated with user's 101 user account 124. In another example, if customization engine 116 determines that the visitor identifier 122 is not associated with a log-in identifier 126, customization engine 116 may generate a customized advertisement based on previous content viewed by user on webpages hosted by web client application server.

Web client application server 112 may transmit the customized advertisement to application 118 to display to user 101. As illustrated, application 118 may display web page 502 (hosted by web server 110) with the customized advertisement in advertisement space 504.

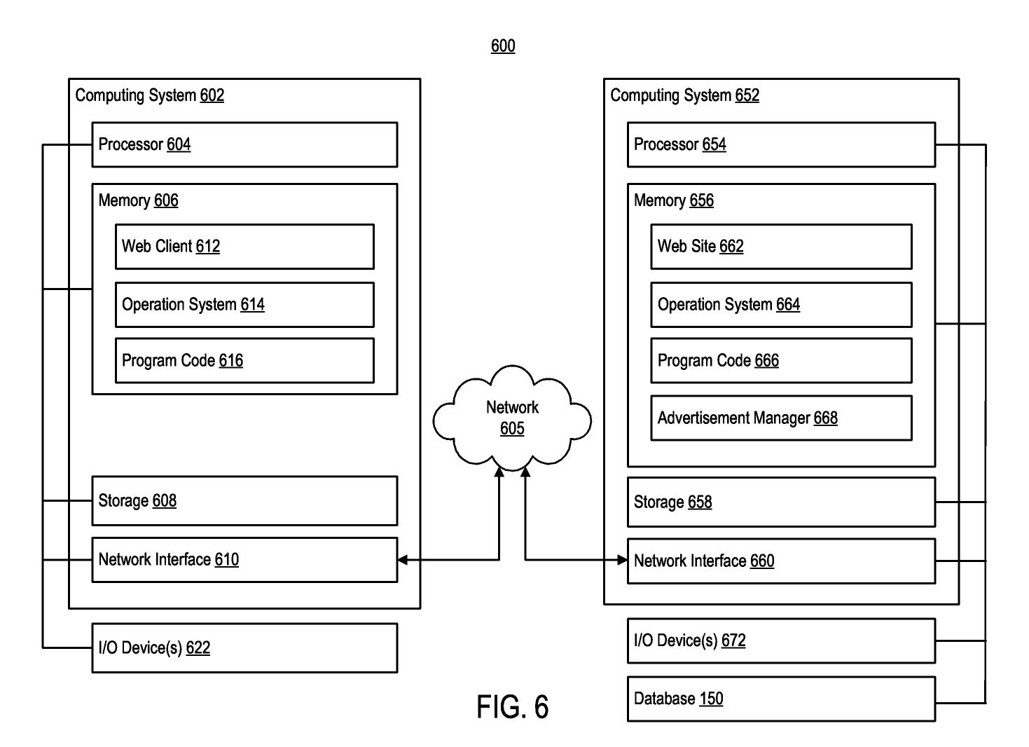

FIG. 6 is a block diagram illustrating a computing environment, according to one embodiment. Computing environment 600 includes computing system 602 and computing system 652. Computing system 602 may be representative of client device 102. Computing system 652 may be representative of management entity 104.

Computing system 602 may include a processor 604, a memory 606, a storage 608, and a network interface 610. In some embodiments, computing system 602 may be coupled to one or more I/O device(s) 622 (e.g., keyboard, mouse, etc.).

Processor 604 retrieves and executes program code 616 (i.e., programming instructions) stored in memory 606, as well as stores and retrieves application data. Processor 604 is included to be representative of a single processor, multiple processors, a single processor having multiple processing cores, and the like. Network interface 610 may be any type of network communications allowing computing system 602 to communicate externally via computing network 605. For example, network interface 610 is configured to enable external communication with computing system 652.

Storage 608 may be, for example, a disk storage device. Although shown as a single unit, storage 608 may be a combination of fixed and/or removable storage devices, such as fixed disk drives, removable memory cards, optical storage, network attached storage (NAS), storage area network (SAN), and the like.

Memory 606 may include application 612, operating system 614, and program code 616. Program code 616 may be accessed by processor 604 for processing (i.e., executing program instructions). Program code 616 may include, for example, executable instructions for communicating with computing system 652 to display one or more pages of website 662. Application 612 may enable a user of computing system 602 to access a functionality of computing system 625. For example, application 612 may access content managed by computing system 652, such as website 662. The content that is displayed to a user of computing system 602 may be transmitted from computing system 652 to computing system 602, and subsequently processed by application 612 for display through a graphical user interface (GUI) of computing system 602.

Computing system 652 may include a processor 654, a memory 656, a storage 658, and a network interface 660. In some embodiments, computing system 652 may be coupled to one or more I/O device(s) 672. In some embodiments, computing system 652 may be in communication with database 150.

Processor 654 retrieves and executes program code 666 (i.e., programming instructions) stored in memory 656, as well as stores and retrieves application data. Processor 604 is included to be representative of a single processor, multiple processors, a single processor having multiple processing cores, and the like. Network interface 660 may be any type of network communications enabling computing system 652 to communicate externally via computing network 605. For example, network interface 660 allows computing system 652 to communicate with computer system 602.

Storage 658 may be, for example, a disk storage device. Although shown as a single unit, storage 658 may be a combination of fixed and/or removable storage devices, such as fixed disk drives, removable memory cards, optical storage, network attached storage (NAS), storage area network (SAN), and the like.

Memory 656 may include website 662, operating system 664, program code 666, and advertisement manager 668. Program code 662 may be accessed by processor 654 for processing (i.e., executing program instructions). Program code 666 may include, for example, executable instructions configured to perform steps discussed above in conjunction with FIGS. 2-4. As an example, processor 654 may access program code 666 to perform operations for determining identifying visitor identifiers and serving a customized advertisement to a web browser/application (e.g., application 612). In another example, processor 654 may access program code 666 to perform operations for generating one or more sets of synthetic identification information. Website 662 may be accessed by computing system 602. For example, website 662 may include content accessed by computing system 602 via a web browser or application.

Advertisement manager 668 may be configured to manage one or more advertisements for computing system 652. For example, advertisement manager 668 may be configured to generate a customized advertisement for display within a webpage hosted by a third party web server. For example, when an advertisement routes an advertisement request to computing system 652, advertisement manager 668 may generate a customized advertisement based on characteristics of the received request. For example, advertisement manger 668 may parse the request for a visitor identifier. Advertisement manager 668 may generate a customized advertisement based on the identified visitor identifier.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, at a management computing system from one or more client computing devices, one or more hypertext transfer protocol (HTTP) requests to access a website associated with the management computing system, wherein each HTTP request comprises a visitor identifier corresponding to a respective client computing device of the one or more client computing devices;
parsing, by the management computing system, each HTTP request to identify the visitor identifier contained therein;
transferring, by the management computing system, one or more visitor identifiers to a remote advertisement server, the remote advertisement server configured to manage advertisements for a plurality of webpages hosted by one or more third party web servers;
receiving, at the management computing system, an advertisement call from a first client computing device of the one or more client computing devices, responsive to the remote advertisement server initiating a bidding process for advertisement space in a third party webpage requested by the first client computing device that was won by an entity associated with the management computing system, the advertisement call comprising a visitor identifier from a web browser executing on the first client computing device;
parsing, by the management computing system, the advertisement call to identify the visitor identifier container therein;
generating, by the management computing system, a customized advertisement based at least on content accessed by the first client computing device while on the website associated with the management computing system; and
transmitting, by the management computing system to the first client computing device, the customized advertisement to the web browser for display with the webpage.

2. The method of claim 1, wherein receiving, by the management computing system, the one or more HTTP requests, comprises:
receiving a visitor cookie included in the HTTP request, wherein the visitor cookie corresponds to the visitor identifier.

3. The method of claim 1, wherein receiving the advertisement call from the web browser executing on the first client computing device is responsive to the web browser communicating with the third party web server based on instructions received in a hypertext markup language (HTML) document transmitted from a third party web server to the first client computing device.

4. The method of claim 1, wherein receiving, by the management computing system, the one or more HTTP requests to access a website, comprises:
receiving log-in information associated with an account, wherein the log-in information is associated with a log-in identifier.

5. The method of claim 4, further comprising:
associating, by the management computing system, the log-in identifier with the visitor identifier; and
storing, by the management computing system, the association in a database.

6. The method of claim 5, wherein generating, by the management computing system, the customized advertisement based at least on content accessed by the first client computing device while on the website associated with the management computing system comprises:
identifying whether the visitor identifier is associated with a log-in identifier;
determining that the visitor identifier is associated with the log-in identifier; and
generating the customized advertisement based on content accessed by the first client computing device and content particular to the account logged into.

7. (canceled)

8. A system, comprising:
a processor in communication with a client computing device; and
a memory having programming instructions stored thereon, which, when executed by the processor, performs an operation comprising:
receiving an advertisement call from the client computing device, responsive to a remote advertisement server initiating a bidding process for advertisement space in a third party webpage requested by the client computing device that was won by an entity associated with the system, the advertisement call comprising identification information from a web browser executing on the client computing device;
identifying that the received identification information comprises a visitor identifier, wherein the visitor identifier is indicative of the client computing device accessing content managed by the system;
generating a customized advertisement based at least on the content accessed by the client computing device; and
transmitting, to the web browser executing on the client computing device, the customized advertisement for display with the webpage.

9. The system of claim 8, wherein the received identification information is a visitor cookie.

10. The system of claim 8, wherein receiving the advertisement call from the web browser executing on the client computing device is indicative of winning a bid for the advertisement.

11. The system of claim 8, further comprising:
identifying that the visitor identifier is associated with a log-in identifier corresponding to a user account managed by the system.

12. The system of claim 11, wherein the log-in identifier is received by the system when the client computing device attempts to log into the user account.

13. The system of claim 12, wherein generating the customized advertisement based at least on content accessed by the client computing device comprises:
identifying whether the visitor identifier is associated with a log-in identifier;
determining that the visitor identifier is associated with the log-in identifier; and
generating the customized advertisement based on content accessed by the client computing device and content particular to the account logged into.

14. (canceled)

15. The system of claim 8, wherein identifying that the received identification information comprises the visitor identifier, comprises:
identifying whether the identification information includes information stored in a database as a result of the client computing device visiting an additional webpage managed by the system.

16. A method, comprising:
receiving, by an advertisement server, a first set of identification information comprising a visitor identifier from a remote computing system, wherein the identification information corresponds to an identification of a client device that has accessed a website hosted by the remote computing system;
receiving, by the advertisement server from a web browser executing on the client device, an advertisement request for an advertisement to be included in an advertisement space of a webpage hosted by a third party web server, the advertisement request comprising a second set of identification information, wherein the advertisement request is triggered by instructions in a hypertext markup language (HTML) document transmitted from the third party web server to the client device, the HTML document comprising instructions for generating the webpage and an address of the advertisement server for requesting the advertisement;
parsing, by the advertisement server, the second set of identification information to identify whether the second set of identification information comprises the visitor identifier;
determining, by the advertisement server, that the second set of identification information comprises the visitor identifier;
initiating, by the advertisement server, a real-time bidding process among a plurality of advertising entities that comprises the remote computing system to determine an entity to fulfill the advertisement request;
determining, by the advertisement server, that the remote computing system won the real-time bidding process; and
prompting the remote computing system to generate a customized advertisement based on content accessed by the client device by routing, by the advertisement server, the advertisement request to the remote computing system.

17. (canceled)

18. The method of claim 16, wherein routing, by the advertisement server, the advertisement request to the remote computing system comprises:
transmitting the identified visitor identifier to the remote computing system.

19. The method of claim 16, further comprising:
assigning, by the advertising server, a unique identifier to the web browser.

20. The method of claim 19, further comprising:
associating, by the advertising server, the unique identifier with the visitor identifier.
